(19) United States
(12) Patent Application Publication
(10) Pub. No.: US 2007/0115451 A1
(43) Pub. Date: May 24, 2007

(54) Lithographic System with Separated Isolation Structures

(75) Inventor: Bausan Yuan, San Jose, CA (US)

Correspondence Address: AKA CHAN LLP, 900 LAFAYETTE STREET, SUITE 710, SANTA CLARA, CA, 95050, US

(73) Assignee: NIKON CORPORATION, Tokyo (JP)

(21) Appl. No.: 11/624,908

(22) Filed: Jan. 19, 2007

Related U.S. Application Data
(62) Division of application No. 10/919,771, filed on Aug. 17, 2004, now abandoned.

(51) Int. Cl. G03B 27/62

(52) U.S. Cl. 355/75; 355/72

(57) ABSTRACT

Methods and apparatus for isolating or separating a reticle stage arrangement from a lens assembly are disclosed. According to one aspect of the present invention, an apparatus includes a reticle stage assembly, a lens assembly, and an isolator assembly. The isolator assembly is arranged to substantially prevent vibrations from being transmitted from the reticle stage assembly to the lens assembly. In one embodiment, the apparatus also includes a frame structure that supports the lens assembly and the reticle stage assembly.

### CROSS-REFERENCE TO RELATED APPLICATIONS

The present application is a divisional of related co-pending U.S. patent application Ser. No. 10/919,771, filed Aug. 17, 2004, which is incorporated herein by reference in its entirety. The present application is also related to co-pending U.S. patent application Ser. No. 09/721,733 and to co-pending U.S. patent application Ser. No. 09/721,734, which are each incorporated herein by reference in their entireties.

### BACKGROUND OF THE INVENTION

1. Field of Invention

The present invention relates generally to semiconductor processing equipment. More particularly, the present invention relates to a lithographic device which uses an isolation system such as an active vibration isolation system to vibrationally isolate a reticle stage from a lens arrangement.

2. Description of the Related Art

For precision instruments such as photolithography machines which are used in semiconductor processing, factors which affect the performance, e.g., accuracy, of the precision instrument generally must be dealt with and, insofar as possible, eliminated. When the performance of a precision instrument is adversely affected, as for example by disturbance forces or vibrations, products formed using the precision instrument may be improperly formed and, hence, defective. For instance, a lithography device such as a photolithography machine which is subjected to vibrations may cause an image projected by the photolithography machine to move, and, as a result, be aligned incorrectly on a projection surface such as a semiconductor wafer surface.

Scanning stages such as wafer scanning stages and reticle scanning stages are often used in semiconductor fabrication processes, and may be included in various photolithography and exposure apparatuses. Wafer scanning stages are generally used to position a semiconductor wafer such that portions of the wafer may be exposed as appropriate for masking or etching. Reticle scanning stages are generally used to accurately position a reticle or reticles for exposure over the semiconductor wafer. Patterns are generally resident on a reticle, which effectively serves as a mask or a negative for a wafer. When a reticle is positioned over a wafer as desired, a beam of light or a relatively broad beam of electrons may be collimated through a reduction lens, and provided to the reticle on which a thin metal pattern is placed. Portions of a light beam, for example, may be absorbed by the reticle while other portions pass through the reticle and are focused onto the wafer.

Many photolithographic systems use an active vibration isolation system (AVIS) to reduce the amount of vibrations which may be transmitted through a lens frame to a lens assembly within the photolithographic system. FIG. 1a is a diagrammatic representation of a photolithographic system which includes an AVIS. A system 100 includes a wafer stage 104 which is supported on a wafer stage base 108 and supports a wafer table 112 which holds a wafer (not shown). A counter mass 116 is also supported on wafer stage base 108. Wafer stage base 108 is positioned substantially atop a frame caster 120 onto which a trim motor 124, which cooperates with counter mass 116 to substantially compensate for reaction forces caused by the scanning of wafer stage 104 and wafer table 112, and for some external vibratory motion, is mounted. In some instances, wafer stage base 108 may be mounted on an AVIS, e.g., AVIS 180 as shown in FIG. 1b, in order to reduce the transmissibility of wafer stage vibrations to frame caster 120 and, hence, to lens frame 132.

Returning to FIG. 1a, a lens assembly 128 is supported on a lens frame 132 which, as shown, is isolated from frame caster 120 through AVIS 136 to reduce vibrations that are transmitted through frame caster 120 to lens assembly 128. Lens frame 132 also supports a reticle stage base 140 on which a reticle fine stage 144 and a reticle coarse stage 148 may move to position a reticle (not shown) positioned on reticle fine stage 144. A trim motor 156, which cooperates with a counter mass 152 to compensate for reaction forces created by scanning reticle fine stage 144 and reticle coarse stage 148, and to reduce the transmission of vibrations to reticle fine stage 144 and reticle coarse stage 148, is supported on lens frame 132. Various sensors 160, e.g., interferometers which measure lateral motion of wafer table 112 and interferometers which measure lateral motion of reticle fine stage 144, are also mounted on lens frame 132.

Often, vibrations associated with the movement of a reticle (not shown) positioned on reticle file stage 144 may be transmitted through reticle stage base 140 to lens frame 132. Such vibrations may adversely affect lens assembly 128 by causing lens assembly 128 to vibrate or otherwise move, thereby causing an image projected through lens 128 onto a wafer (not shown) on wafer table 112 to be inaccurately projected. In other words, any images formed on a surface of a wafer (not shown) on wafer table 112 may not be accurately formed, i.e., the images may not be precise. As a result, the integrity of the wafer (not shown) positioned on wafer table 112 may be compromised.

Therefore, what is needed is a method and an apparatus for reducing vibrations which are transmitted through a lens frame to a lens assembly. More specifically, what is desired is a system which effectively isolates a reticle stage assembly from a lens assembly in a photolithographic system such that vibrations associated with the reticle stage assembly may be substantially prevented from adversely affecting the operation of the lens assembly and, hence, the processing of a wafer positioned beneath the lens assembly.

BRIEF SUMMARY OF THE INVENTION

The present invention relates to separated isolation structures which enable a reticle stage arrangement to be vibrationally isolated from a lens assembly. According to one aspect of the present invention, an apparatus includes a reticle stage assembly, a lens assembly, and an isolator assembly. The isolator assembly is arranged to substantially prevent vibrations from being transmitted from the reticle stage assembly to the lens assembly. In one embodiment, the apparatus also includes a frame structure that supports the lens assembly and the reticle stage assembly. In such an embodiment, the isolator assembly is mounted on the frame structure.

An isolator which substantially prevents vibrations from being transmitted through a lens frame to a lens assembly allows the accuracy with which images may be formed on the surface of a wafer to be improved. When a lens of a lens assembly is substantially prevented from vibrating or oscillating, the position of the lens relative to a reticle and a wafer may be more accurately determined and, as a result, the reticle and the wafer may be positioned more accurately relative to the lens. Isolating a reticle stage structure from a lens assembly typically reduces the transmission of vibrations which are generated when a reticle stage moves to a lens assembly. As such, an overall imaging process which uses the lens assembly is less likely to be compromised due to a vibrating lens assembly.

According to another aspect of the present invention, a lithographic apparatus includes a wafer stage assembly, a reticle stage assembly, a lens assembly, and a first isolation system. The wafer stage assembly includes a wafer table that supports a wafer and serves to scan the wafer. The reticle stage includes a reticle table that supports a reticle and serves to scan the reticle. The lens assembly, which is disposed substantially between the wafer stage assembly and the reticle stage assembly, is isolated from the reticle stage assembly to substantially prevent vibrations associated with the reticle stage assembly from being transmitted to the lens assembly.

In one embodiment, the first isolation system is further arranged to substantially compensate for a shift in a center of gravity associated with the reticle stage assembly. In another embodiment, the first isolation system is one of an active vibration isolation system and a piezoelectric actuator.

These and other advantages of the present invention will become apparent upon reading the following detailed descriptions and studying the various figures of the drawings.

### BRIEF DESCRIPTION OF THE DRAWINGS

The invention may best be understood by reference to the following description taken in conjunction with the accompanying drawings in which:

FIG. 1a is a diagrammatic representation of a photolithographic system which includes one active vibration isolation system (AVIS).

FIG. 1b is a diagrammatic representation of a photolithographic system which includes an AVIS which separates a lens frame from a frame caster and an AVIS which separates a wafer stage base from the frame caster.

FIG. 2a is a diagrammatic representation of a first lithographic system which includes an AVIS that substantially isolates a reticle stage structure from a lens assembly in accordance with an embodiment of the present invention.

FIG. 2b is a diagrammatic representation of a second lithographic system which includes an AVIS that substantially isolates a reticle stage structure from a lens assembly will be described in accordance with an embodiment of the present invention.

FIG. 3 is a diagrammatic representation of a lithographic system which includes a piezoelectric actuator assembly that substantially prevents vibrations from being transmitted between a reticle stage and a lens assembly in accordance with an embodiment of the present invention.

FIG. 4 is a control block diagram which illustrates the control logic associated with enabling the movement of a reticle to substantially track the movement of a wafer in accordance with an embodiment of the present invention.

FIG. 5 is a diagrammatic representation of a lens assembly and an interferometer system in accordance with an embodiment of the present invention.

FIG. 6 is a diagrammatic representation of a photolithography apparatus in accordance with an embodiment of the present invention.

FIG. 7 is a process flow diagram which illustrates the steps associated with fabricating a semiconductor device in accordance with an embodiment of the present invention.

FIG. 8 is a process flow diagram which illustrates the steps associated with processing a wafer, i.e., step 1304 of FIG. 7, in accordance with an embodiment of the present invention.

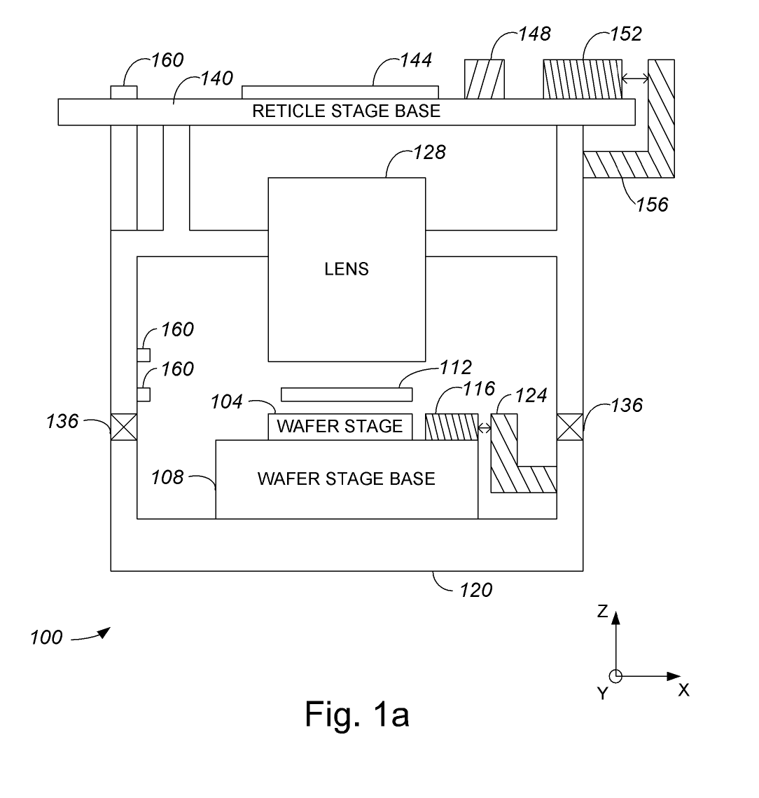

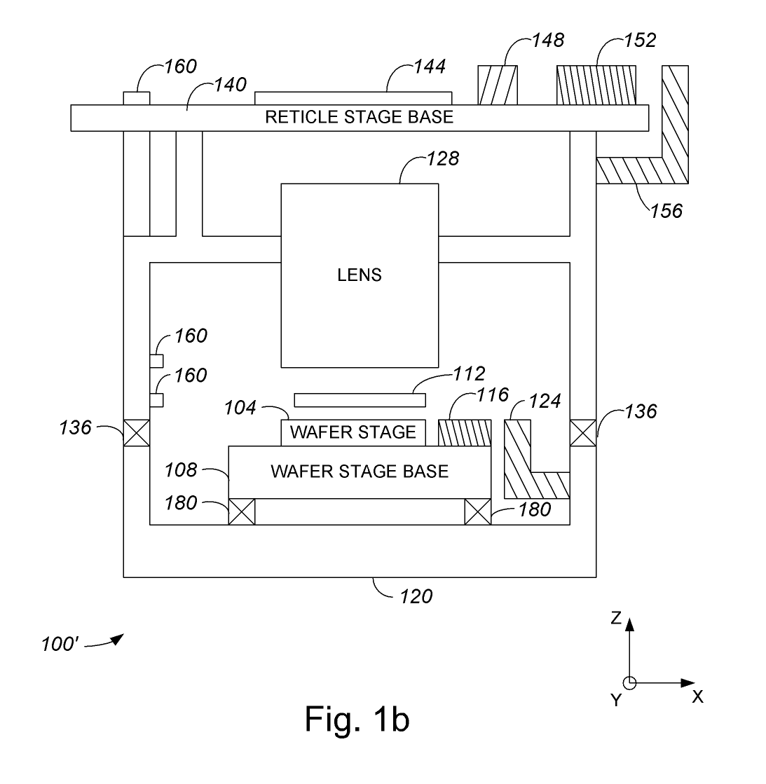

### DETAILED DESCRIPTION OF THE INVENTION

Preventing a lens assembly of a photolithography apparatus from being subjected to significant vibrations is crucial to ensure the accuracy with which an image may be transmitted through the lens assembly to the surface of a wafer during a semiconductor fabrication process. Such vibrations may stem from the movement of a wafer stage, or from the movement of a reticle stage, for example. In many photolithographic systems, a reticle stage assembly and a lens assembly may be supported by a common frame, e.g., an overall lens frame. As a result, any vibrations associated with the reticle stage assembly may be transmitted through the lens frame to the lens assembly.

By preventing vibrations from being transmitted through a lens frame to a lens assembly, the accuracy with which images may be formed on the surface of a wafer through the use of the lens assembly may be improved. Isolating a reticle stage structure from a lens assembly typically reduces the transmission of vibrations which are generated when a reticle stage moves to a lens assembly. In one embodiment, a reticle stage structure may be isolated from a lens frame which supports a lens assembly through the use of an active vibration isolation system (AVIS). Alternatively, a reticle stage structure may be isolated from a lens frame through the use of a system which includes piezoelectric actuators.

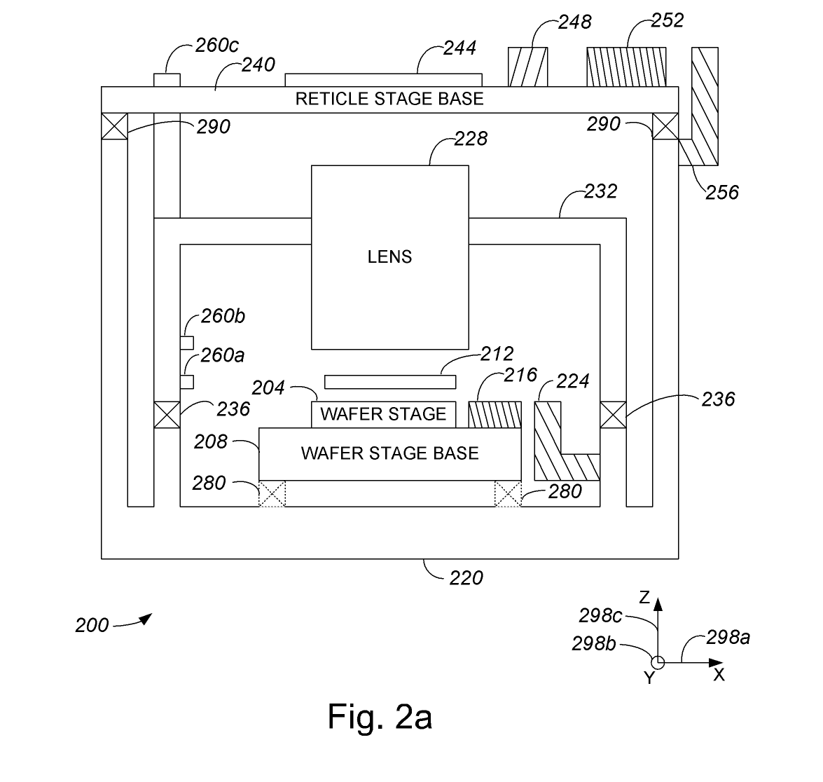

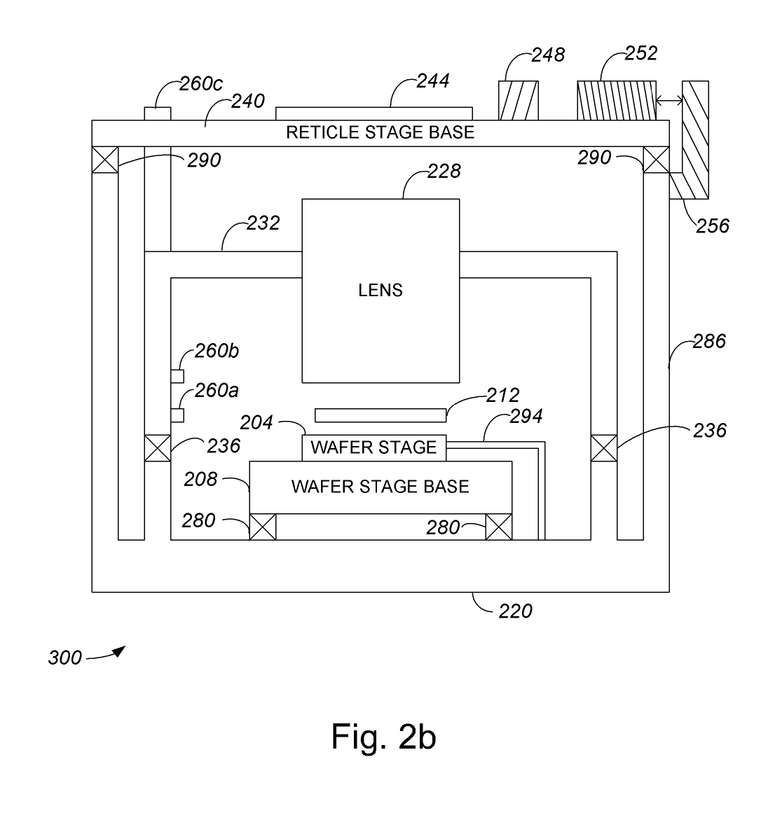

With reference to FIG. 2a, one lithographic system which includes an AVIS that substantially isolates a reticle stage structure from a lens assembly will be described in accordance with an embodiment of the present invention. A lithographic system 200 includes a wafer stage 204 which is supported on a wafer stage base 208 and supports a wafer table 212 which holds a wafer (not shown). Typically, a wafer (not shown) may be held on wafer table 212 by a wafer chuck (not shown). In one embodiment, wafer stage 204 may be a coarse stage which enables a wafer (not shown) supported on wafer table 212 to undergo coarse movements and wafer table 212 may be a fine stage which enables the wafer to undergo fine movements. A counter mass 216 is positioned on wafer stage base 208 and is arranged to absorb some reaction forces generated when wafer stage 204 or wafer table 212 moves. A trim motor 224, which is mounted to a frame caster 220, may prevent external vibrations or oscillations from being transmitted from frame caster 220, or a grounding surface, to counter mass 216 such that the movement of wafer stage 204 or wafer table 212 is not significantly affected by external vibrations.

In the embodiment as shown, wafer stage base 208 is isolated from a frame caster 220, e.g., a grounded surface, through the use of an AVIS 280 positioned substantially atop frame caster 280. AVIS 280 serves to prevent a significant amount of wafer stage vibrations from adversely affecting a lens assembly 228, and to prevent external vibrations from affecting wafer table 212. AVIS 280 may generally include either a “passive isolator” such as an air mount or an “active isolator” such as a voice coil motor. It should be appreciated that AVIS 280 is optional and is not included in system 200 in some embodiments. By way of example, for an embodiment in which counter mass 216 is effective in balancing reaction forces associated with wafer stage 204 such that there is substantially no center of gravity shift associated with wafer stage 204, then AVIS 280 may be eliminated.

Wafer stage 204 and wafer table 212 are each typically arranged to move in multiple degrees of freedom, e.g., between three to six degrees of freedom, such that a wafer (not shown) may be positioned relative to a lens assembly 228, e.g., a projection optical system. As will be appreciated by those skilled in the art, movement in three degrees of freedom is typically translational or lateral movement along an X-axis 298a, lateral movement along a Y-axis 298b, and rotational movement about a Z-axis 298c, while movement in six degrees of freedom includes lateral movement along each axis 298 as well as rotational movement about each axis 298. The choice of the number of degrees of freedom for wafer table 212 is generally dependent upon the requirements of system 200. For example, when AVIS 280 is not included in system 200, then wafer table 212 may move in six degrees of freedom such that a low transmissibility and a high bandwidth may be achieved. When wafer table 212 may move in six degrees of freedom, then image distortion associated with images projected through lens assembly 228 onto a wafer (not shown) supported on wafer table 212 may be reduced. Often, when wafer table 212 is arranged to move in three degrees of freedom, AVIS 280 is included in system 200 to reduce the amount of external vibrations transmitted to wafer table 212.

Lens assembly 228 is supported on a lens frame 232 which is effectively vibrationally isolated from frame caster 220 by an AVIS 236 such that vibrations transmitted between frame caster 220 and lens assembly 228 may be reduced. Like AVIS 280, AVIS 236 may be either a passive isolator or an active isolator. Lens assembly 228 supports sensors 260, which are generally position or motion measurement sensors such as interferometers, which are arranged to determine positions of components of system 200. By way of example, sensor 260a may be arranged to effectively measure a position of a wafer (not shown) mounted on wafer table 212, while sensor 260b may be arranged to measure a position of a lens assembly 228. Sensor 260c may be used to measure a position, e.g., a lateral position, of a reticle (not shown) supported on a reticle fine stage 244. It should be understood that system 200 includes various other sensors which have not been shown for ease of illustration. Such sensors include, but are not limited to, sensors which measure a position of wafer table 212 along Z-axis 298c, sensors which measure a position of reticle stage base 240 along Z-axis 298c, and sensors which measure a position of the top of lens assembly 228 along X-axis 298a.

A reticle support frame 286 is arranged to support a reticle stage base 240 on which a reticle fine stage 244 and a reticle coarse stage 248 may move to position a reticle (not shown) held in a reticle fine stage 244. In general, reticle support frame 286, lens frame 232, and frame caster 220 may form an overall support frame. It should be appreciated that although both a reticle fine stage 244 and a reticle coarse stage 248 are included in system 200, some systems may include only a single reticle stage. A counter mass 252 which is positioned on reticle stage base 240 and a trim motor 256, which is mounted on reticle support frame 286 such that trim motor 256 is substantially isolated from reticle stage base 240, serve to position counter mass 252 when a reticle (not shown) is scanned and to reduce the transmission of external vibrations to reticle fine stage 244 and reticle coarse stage 248, respectively.

An AVIS 290 is arranged to isolate reticle fine stage 244 and reticle coarse stage 248 from lens assembly 228 by preventing significant vibrations from being transmitted from either or both reticle fine stage 244 and reticle coarse stage 248 through reticle stage base 240 to lens assembly 228. As shown, AVIS 290 is also arranged to substantially isolate reticle fine stage 244 and reticle coarse stage 248 from sensors 260a, 260b, 260c thereby reducing the effect of external vibrations on the operation of sensors 260a, 260b, 260c. AVIS 290 is effectively mounted on frame caster 220, as for example through reticle support frame 286. In one embodiment, AVIS 290 may be mounted substantially directly to frame caster 220. AVIS 290, in addition to being used to reduce the amount of vibrations transmitted from reticle fine stage 244 and reticle coarse stage 248, may generally serve to compensate for a shift in the center of gravity associated with a reticle stage assembly which generally includes reticle fine stage 244 and reticle coarse stage 248. When counter mass 252 is used, then AVIS 290 is not necessarily used for center of gravity shift compensation associated with reticle fine stage 244 and reticle coarse stage 248, and is instead used to reduce the transmissibility of vibrations generated by the movement of reticle fine stage 244 or reticle coarse stage 248.

By isolating reticle stage base 240 from lens assembly 228 using AVIS 290, lens assembly 228 is effectively not subjected to vibrations generated when a reticle (not shown) supported on reticle fine stage 244 is scanned. Hence, the accuracy associated with system 200 may be improved, as lens assembly 228 is less likely to move and, further, sensors 260 are also less likely to move. AVIS 290 may be substantially any suitable isolation system which is effective in preventing reticle stage vibrations from being transmitted to lens assembly 228. Suitable isolation system typically include, but are not limited to, various air mounts and voice coil motors.

A lithographic system which includes an AVIS that prevents significant reticle stage vibrations from affecting a lens assembly, e.g., AVIS 290 of FIG. 2a, may generally vary widely. By way of example, as discussed above, such a system may include both reticle fine stage 244 and reticle coarse stage 248. Alternatively, such a system may include only a single reticle stage. In addition, a system which includes an AVIS that isolates an overall reticle stage assembly from a lens assembly may or may not include an AVIS that isolates a wafer stage assembly from a frame caster.

FIG. 2b is a diagrammatic representation of a second lithographic system which includes an AVIS that substantially isolates a reticle stage structure from a lens assembly will be described in accordance with an embodiment of the present invention. A lithographic system 300 is similar to lithographic system 200 of FIG. 2a, and includes wafer stage 204, wafer stage base 208, and wafer table 212. System 300 also includes reticle fine stage 244, reticle coarse stage 248, and reticle stage base 240 which are substantially isolated from lens assembly 228 by AVIS 290.

In some situations, the use of a counter mass and a trim motor with a wafer stage assembly, e.g., counter mass 216 and trim motor 224 of FIG. 2a, may not be desirable, as for example when the mass of system 300 is to be reduced. When a counter mass and a trim motor are not substantially used with a wafer stage assembly, a reaction frame 294 may instead be used to effectively “absorb” reaction forces associated with the movement of wafer stage 204 and wafer table 212. Specifically, reaction frame 294 may transmit reaction forces and vibrations to frame caster 220.

When reaction frame 294 is used, avis 280 is used to reduce the transmissibility of vibrations between wafer stage base 208 and frame caster 220. In other words, when reaction frame 294 is used in lieu of a counter mass and a trim motor, avis 280 is typically included in system 300, i.e., avis 280 is effectively no longer optional. As previously mentioned, the inclusion of AVIS 280 generally entails the use of a three degree of freedom wafer table 212 in system 300, although it should be appreciated that a six degree of freedom wafer table 212 may instead be used.

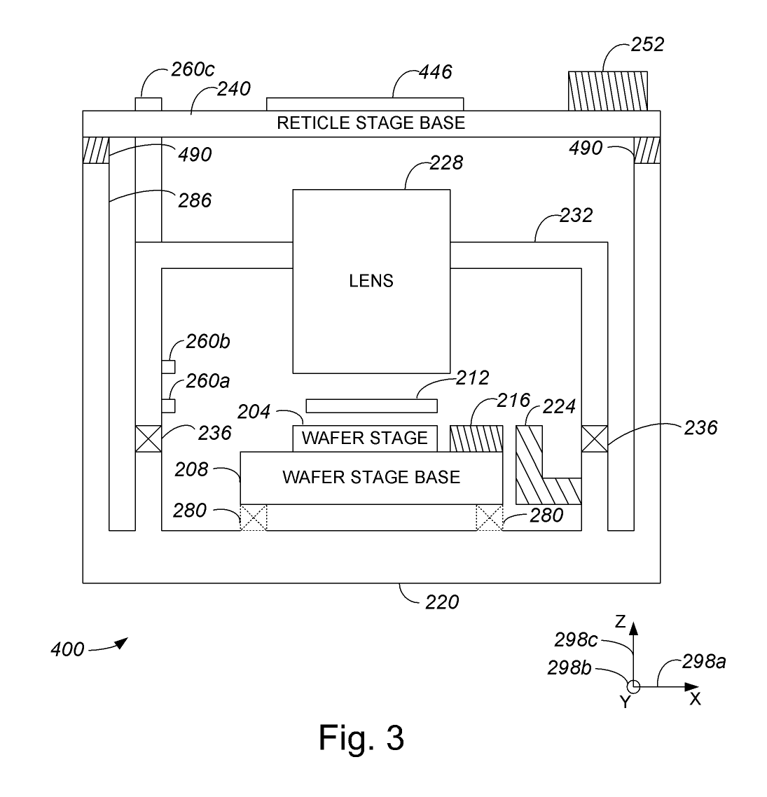

While the use of AVIS 290 is effective in reducing the transmissibility of vibrations resulting from the movement of reticle fine stage 244 or reticle coarse stage 148 to lens assembly 128, aligning AVIS 290 within system 300 may be difficult. For example, difficulties may be the result a relatively low stiffness in air mounts and voice coil motors associated with AVIS 290. In one embodiment, a piezoelectric actuator assembly may be used instead of an AVIS to prevent vibrations from being transmitted between a reticle stage and a lens assembly. With reference to FIG. 3, a lithographic system which includes a piezoelectric actuator assembly that substantially prevents vibrations from being transmitted between a reticle stage and a lens assembly will be described in accordance with an embodiment of the present invention. A lithographic system 400 includes lens assembly 228, which is supported on lens frame 232. Reticle stage base 240 supports a reticle stage 446 which is arranged to move a reticle (not shown) that is positioned atop reticle stage 446.

A piezoelectric actuator assembly 490 is arranged to isolate reticle stage base 240, reticle stage 446, and counter mass 252 from lens assembly 228 such that vibrations associated with the movement of reticle stage 446 may be substantially prevented from being transmitted to lens assembly 228. In general, when piezoelectric actuator assembly 490 is used instead of an AVIS, i.e., instead of AVIS 290 of FIGS. 2a and 2b, trim motor 256 as shown in FIGS. 2a and 2b is not needed within system 400. Piezoelectric actuator assembly 490 may include actuators with a relatively fast response time that effectively maintain a desired position along Z-axis 298c, and about X-axis 298a and Y-axis 298b. It should be understood that in order to control a position along Z-axis 298c, and about X-axis 298a and Y-axis 298b, feedback signals may be measured between lens assembly 228 and reticle stage base 240. In one embodiment, piezoelectric actuator assembly 490 may include voice coil motors instead of piezoelectric actuators to control position relative to X-axis 298a and Y-axis 298b, and about Z-axis 298c, since the accuracy requirements generally associated with such position is relatively low.

Although the stiffness associated with piezoelectric actuator assembly 490 typically enables piezoelectric actuator assembly 490 to be aligned more readily than an AVIS, e.g., AVIS 290 of FIGS. 2a and 2b, when the stiffness of piezoelectric actuators included in piezoelectric actuator assembly 490 is too high, there may be disturbance effects associated with piezoelectric actuator assembly 490. In general, the amount of vibration transmitted from caster 220 to reticle stage base 240 is dependent upon the stiffness of piezoelectric actuator 490. Adding a component made of rubber or a material with characteristics similar to rubber, in one embodiment, to piezoelectric actuator assembly 490 may serve to reduce vibrations from caster 220.

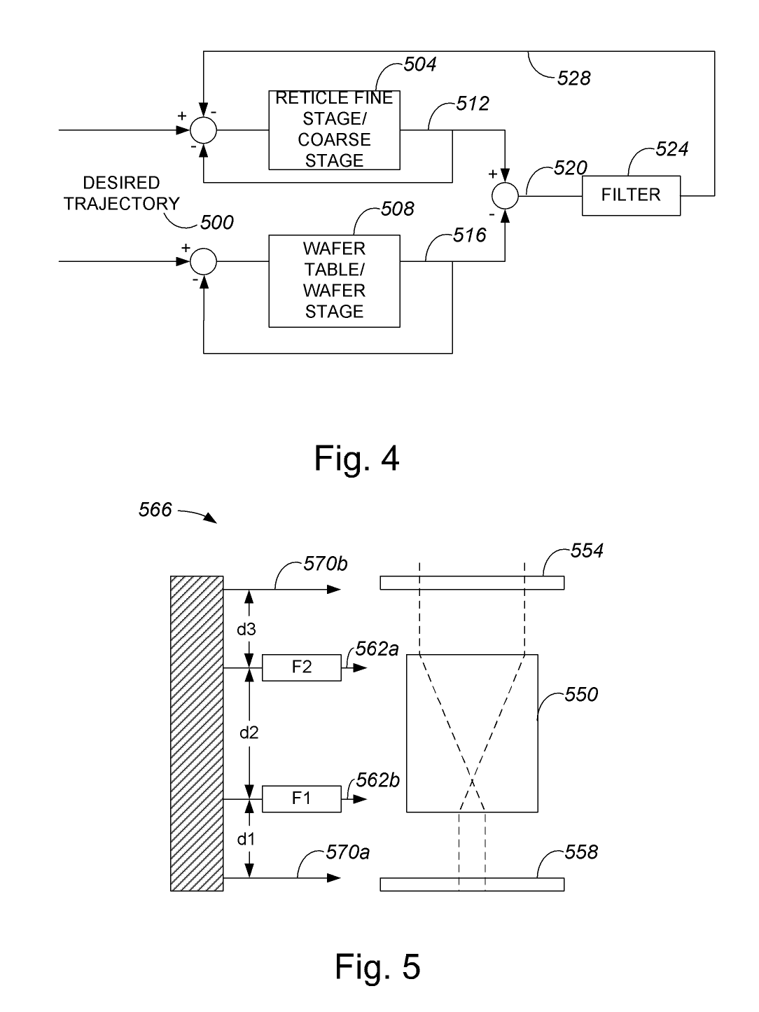

Typically, a reticle is arranged to track the movement of a wafer during a lithography process. As such, when the actual trajectories of the wafer and the reticle differ, the trajectory of the reticle is generally corrected or adjusted such that the trajectory of the reticle substantially matches the trajectory of the wafer. FIG. 4 is a control block diagram which illustrates the control logic associated with enabling the movement of a reticle to substantially track the movement of a wafer in accordance with an embodiment of the present invention. A desired trajectory 500 is provided, e.g., through a controller arrangement, to a reticle stage assembly 504 and a wafer stage assembly 508. In the described embodiment, desired trajectory 500 is specified using at least lateral positions along an X-axis and a Y-axis, as well as rotational positions about a Z-axis.

Reticle stage assembly 504 and wafer stage assembly 508 may then move a reticle and a wafer, respectively. A reticle output position 512 which is associated with the position to which reticle stage assembly 504 has moved and a wafer output position 516 which is associated with the position to which wafer stage assembly 508 has move may be fed back to reticle stage assembly 504 and wafer stage assembly 508, respectively. When wafer stage assembly 508 includes a six degree of freedom wafer table, wafer output position 516 may include up to six coordinates, e.g., translational and rotational coordinates associated with an X-axis, a Y-axis, and a Z-axis. In other words, information relating to every degree of freedom associated with wafer stage assembly 508 may be fed back to wafer stage assembly 508. While the position along the X-axis and the Y-axis, as well as the position about the Z-axis, of a wafer table included in wafer stage assembly 508 may be adjusted to enable the wafer table to track a desired trajectory using information that is fed back, the position of the wafer table may also be adjusted or repositioned based on the information that is fed back to reduce image distortion, e.g., by altering a rotational position about the X-axis and the Y-axis and a translational position along the Z-axis.

In general, reticle output position 512 is measured laterally along an X-axis and a Y-axis, and rotationally about a Z-axis. Wafer output position 516 may generally include lateral and rotational measurements about an X-axis, a Y-axis, and a Z-axis. A wafer stage controller (not shown) uses wafer output position 516 and desired trajectory 500 to correct errors in the stage position. A reticle stage controller (not shown) takes reticle output position 512, desired trajectory 500, and filter output 528 to generate a force command to move the stage.

Reticle output position 512 and wafer output position 516, which typically represent the current positions of a reticle and a wafer, respectively, may be processed to create an error signal 520. That is, the difference between the trajectories, e.g., as measured along an X-axis and a Y-axis, and about a Z-axis, of the reticle and the wafer may effectively be determined by determining the difference between the current position of the reticle and the current position of the wafer. When the difference between the current positions is substantially negligible, then the indication may be that the actual trajectory followed by reticle stage assembly 504 is currently successfully tracking the actual trajectory of wafer stage assembly 508.

When there is a difference between the current or actual positions of a reticle and a wafer, then error signal 520 is passed through a filter 524 which is arranged to filter out any lens vibrations associated with a lens assembly of a lithography apparatus, e.g., lens assembly 228 of FIGS. 2a, 2b, and 3. That is, filter 524 may be used to effectively separate out lens body vibrations from stage motion in error signal 520. Filter 524 typically has parameters which may be determined using an interferometer system associated with the lens assembly, as will be discussed below with respect to FIG. 5. In general, filter 524 is added to the interferometer system associated with the lens assembly, and may be substantially any suitable filter which is effective to filter out vibrational components, e.g., vibrational components in lens body vibrations, that have an effect on either or both reticle output position 512 and wafer output position 516. Suitable filters may include, but are not limited to, low pass filters and notch filters. As will be appreciated by those skilled in the art, a suitable filter may be selected based upon the characteristics of the vibrational components.

Once error signal 520 is filtered, the resultant filtered error signal 528 is provided as input to reticle stage assembly 504. As a result, filtered error signal 528, reticle output position 512, and desired trajectory 500 may be used to substantially dictate the movement of reticle stage assembly 504 such that reticle stage assembly 504 allows a reticle supported thereon to follow the trajectory of a wafer supported on wafer stage assembly 508.

Filter 524, as previously mentioned, includes parameters which may be selected depending upon readings generated from an interferometer system. FIG. 5 is a diagrammatic representation of a lens assembly and an interferometer system in accordance with an embodiment of the present invention. A lens assembly 550 is generally positioned between a reticle stage assembly 554 and a wafer stage assembly 558. Specifically, lens assembly 550 is positioned between a reticle stage base and a wafer table which supports a wafer

Reference beams 562 and a measurement beam 570a which are associated with an interferometer system 566 are used to determine suitable parameters, e.g., parameters F1 and F2, for filter 524 of FIG. 4. In general, vibrations of lens assembly 550 are effectively not compensated for. Rather, vibrations of wafer stage assembly 558 are controlled using parameters F1, F2. In one embodiment, reference beam 562a and measurement beam 570b may be used such that parameters F1, F2 may be chosen to effectively control vibrations of wafer stage assembly 558 and reticle stage assembly 554. Parameters F1, F2 may be changed when the characteristics of vibrations changes, e.g., when oscillations increase or decrease in either frequency or magnitude.

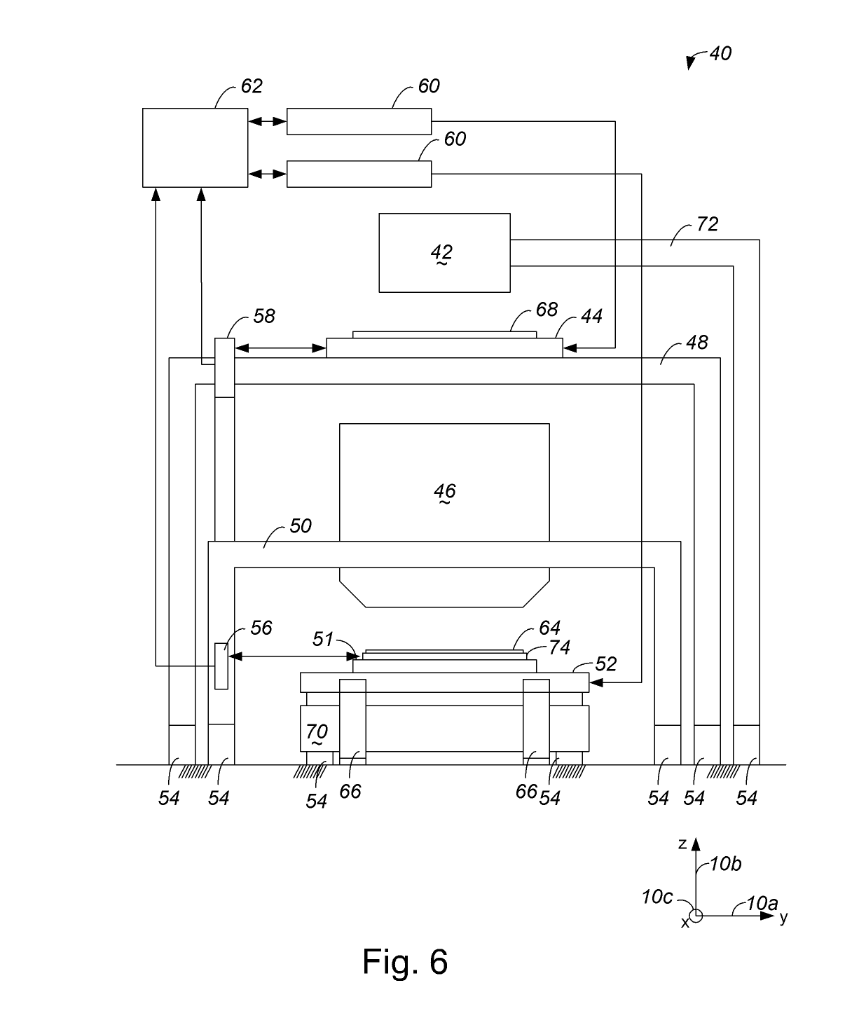

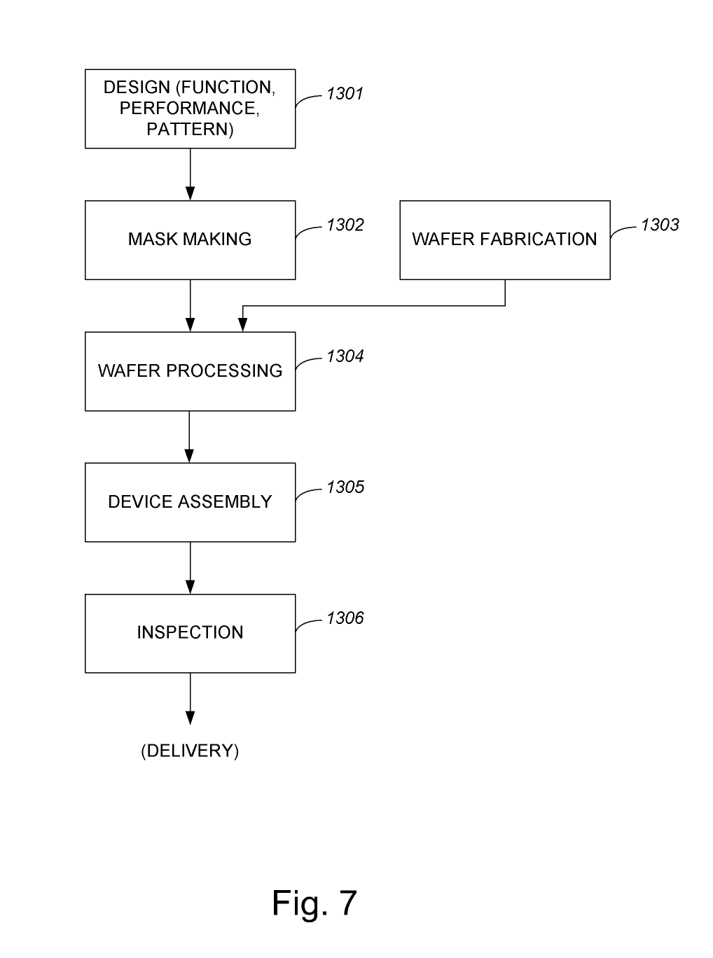

With reference to FIG. 6, a general photolithography apparatus which may include an AVIS which reduces vibrations transmitted from a reticle stage to a lens assembly will be described in accordance with an embodiment of the present invention. A photolithography apparatus (exposure apparatus) 40 includes a wafer positioning stage 52 that may be driven by a planar motor (not shown), as well as a wafer table 51 that is magnetically coupled to wafer positioning stage 52 by utilizing an EI-core actuator. The planar motor which drives wafer positioning stage 52 generally uses an electromagnetic force generated by magnets and corresponding armature coils arranged in two dimensions. A wafer 64 is held in place on a wafer holder or chuck 74 which is coupled to wafer table 51. Wafer positioning stage 52 is arranged to move in multiple degrees of freedom, e.g., between three to six degrees of freedom, under the control of a control unit 60 and a system controller 62. The movement of wafer positioning stage 52 allows wafer 64 to be positioned at a desired position and orientation relative to a projection optical system 46.

Wafer table 51 may be levitated in a z-direction 10b by any number of voice coil motors (not shown), e.g., three voice coil motors. In the described embodiment, at least three magnetic bearings (not shown) couple and move wafer table 51 along a y-axis 10a. The motor array of wafer positioning stage 52 is typically supported by a base 70. Base 70 is supported to a ground via isolators 54. Reaction forces generated by motion of wafer stage 52 may be mechanically released to a ground surface through a frame 66. One suitable frame 66 is described in JP Hei 8-166475 and U.S. Pat. No. 5,528,118, which are each herein incorporated by reference in their entireties.

An illumination system 42 is supported by a frame 72. Frame 72 is supported to the ground or a frame caster (not shown) via isolators 54. Illumination system 42 includes an illumination source, and is arranged to project a radiant energy, e.g., light, through a mask pattern on a reticle 68 that is supported by and scanned using a reticle stage which includes a coarse stage and a fine stage. The radiant energy is focused through projection optical system 46, which is supported on a projection optics frame 50 and may be supported to the ground or a frame caster (not shown) through isolators 54. Suitable isolators 54 include those described in JP Hei 8-330224 and U.S. Pat. No. 5,874,820, which are each incorporated herein by reference in their entireties. In one embodiment, at least one of isolators 54 may be an AVIS.

A first interferometer 56 is supported on projection optics frame 50, and functions to detect the position of wafer table 51. Interferometer 56 outputs information on the position of wafer table 51 to system controller 62. In one embodiment, wafer table 51 has a force damper which reduces vibrations associated with wafer table 51 such that interferometer 56 may accurately detect the position of wafer table 51. A second interferometer 58 is supported on projection optical system 46, and detects the position of reticle stage 44 which supports a reticle 68. Interferometer 58 also outputs position information to system controller 62. Reticle stage 44 is supported on a reticle stage frame 48 which may include at least one AVIS which prevents vibrations associated with reticle stage 44 from being transmitted to projection optical system 46.

It should be appreciated that there are a number of different types of photolithographic apparatuses or devices. For example, photolithography apparatus 40, or an exposure apparatus, may be used as a scanning type photolithography system which exposes the pattern from reticle 68 onto wafer 64 with reticle 68 and wafer 64 moving substantially synchronously. In a scanning type lithographic device, reticle 68 is moved perpendicularly with respect to an optical axis of a lens assembly (projection optical system 46) or illumination system 42 by reticle stage 44. Wafer 64 is moved perpendicularly to the optical axis of projection optical system 46 by a wafer stage 52. Scanning of reticle 68 and wafer 64 generally occurs while reticle 68 and wafer 64 are moving substantially synchronously.

Alternatively, photolithography apparatus or exposure apparatus 40 may be a step-and-repeat type photolithography system that exposes reticle 68 while reticle 68 and wafer 64 are stationary. In one step and repeat process, wafer 64 is in a substantially constant position relative to reticle 68 and projection optical system 46 during the exposure of an individual field. Subsequently, between consecutive exposure steps, wafer 64 is consecutively moved by wafer positioning stage 52 perpendicularly to the optical axis of projection optical system 46 and reticle 68 for exposure. Following this process, the images on reticle 68 may be sequentially exposed onto the fields of wafer 64 so that the next field of semiconductor wafer 64 is brought into position relative to illumination system 42, reticle 68, and projection optical system 46.

It should be understood that the use of photolithography apparatus or exposure apparatus 40, as described above, is not limited to being used in a photolithography system for semiconductor manufacturing. For example, photolithography apparatus 40 may be used as a part of a liquid crystal display (LCD) photolithography system that exposes an LCD device pattern onto a rectangular glass plate or a photolithography system for manufacturing a thin film magnetic head.

The illumination source of illumination system 42 may be g-line (436 nanometers (nm)), i-line (365 nm), a KrF excimer laser (248 nm), an ArF excimer laser (193 nm), and an F2-type laser (157 nm). Alternatively, illumination system 42 may also use charged particle beams such as x-ray and electron beams. For instance, in the case where an electron beam is used, thermionic emission type lanthanum hexaboride (LaB6) or tantalum (Ta) may be used as an electron gun. Furthermore, in the case where an electron beam is used, the structure may be such that either a mask is used or a pattern may be directly formed on a substrate without the use of a mask.

With respect to projection optical system 46, when far ultra-violet rays such as an excimer laser is used, glass materials such as quartz and fluorite that transmit far ultra-violet rays is preferably used. When either an F2-type laser or an x-ray is used, projection optical system 46 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. Examples of a catadioptric type of optical system include, but are not limited to, those described in Japan Patent Application Disclosure No. 8-171054 published in the Official gazette for Laid-Open Patent Applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave mirror. Japan Patent Application Disclosure (Hei) No. 8-334695 published in the Official gazette for Laid-Open Patent Applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave mirror, but without a beam splitter, and may also be suitable for use with the present invention.

Further, in photolithography systems, when linear motors (see U.S. Pat. Nos. 5,623,853 or 5,528,118, which are each incorporated herein by reference in their entireties) are used in a wafer stage or a reticle stage, the linear motors may be either an air levitation type that employs air bearings or a magnetic levitation type that uses Lorentz forces or reactance forces. Additionally, the stage may also move along a guide, or may be a guideless type stage which uses no guide.

Alternatively, a wafer stage or a reticle stage may be driven by a planar motor which drives a stage through the use of electromagnetic forces generated by a magnet unit that has magnets arranged in two dimensions and an armature coil unit that has coil in facing positions in two dimensions. With this type of drive system, one of the magnet unit or the armature coil unit is connected to the stage, while the other is mounted on the moving plane side of the stage.

Movement of the stages as described above generates reaction forces which may affect performance of an overall photolithography system. Reaction forces generated by the wafer (substrate) stage motion may be mechanically released to the floor or ground by use of a frame member as described above, as well as in U.S. Pat. No. 5,528,118 and published Japanese Patent Application Disclosure No. 8-166475. Additionally, reaction forces generated by the reticle (mask) stage motion may be mechanically released to the floor (ground) by use of a frame member as described in U.S. Pat. No. 5,874,820 and published Japanese Patent Application Disclosure No. 8-330224, which are each incorporated herein by reference in their entireties.

Isolaters such as isolators 54 may generally be associated with an active vibration isolation system (AVIS). An AVIS generally controls vibrations associated with forces 112, i.e., vibrational forces, which are experienced by a stage assembly or, more generally, by a photolithography machine such as photolithography apparatus 40 which includes a stage assembly.

A photolithography system according to the above-described embodiments may be built by assembling various subsystems in such a manner that prescribed mechanical accuracy, electrical accuracy, and optical accuracy are maintained. In order to maintain the various accuracies, prior to and following assembly, substantially every optical system may be adjusted to achieve its optical accuracy. Similarly, substantially every mechanical system and substantially every electrical system may be adjusted to achieve their respective desired mechanical and electrical accuracies. The process of assembling each subsystem into a photolithography system includes, but is not limited to, developing mechanical interfaces, electrical circuit wiring connections, and air pressure plumbing connections between each subsystem. There is also a process where each subsystem is assembled prior to assembling a photolithography system from the various subsystems. Once a photolithography system is assembled using the various subsystems, an overall adjustment is generally performed to ensure that substantially every desired accuracy is maintained within the overall photolithography system. Additionally, it may be desirable to manufacture an exposure system in a clean room where the temperature and humidity are controlled.

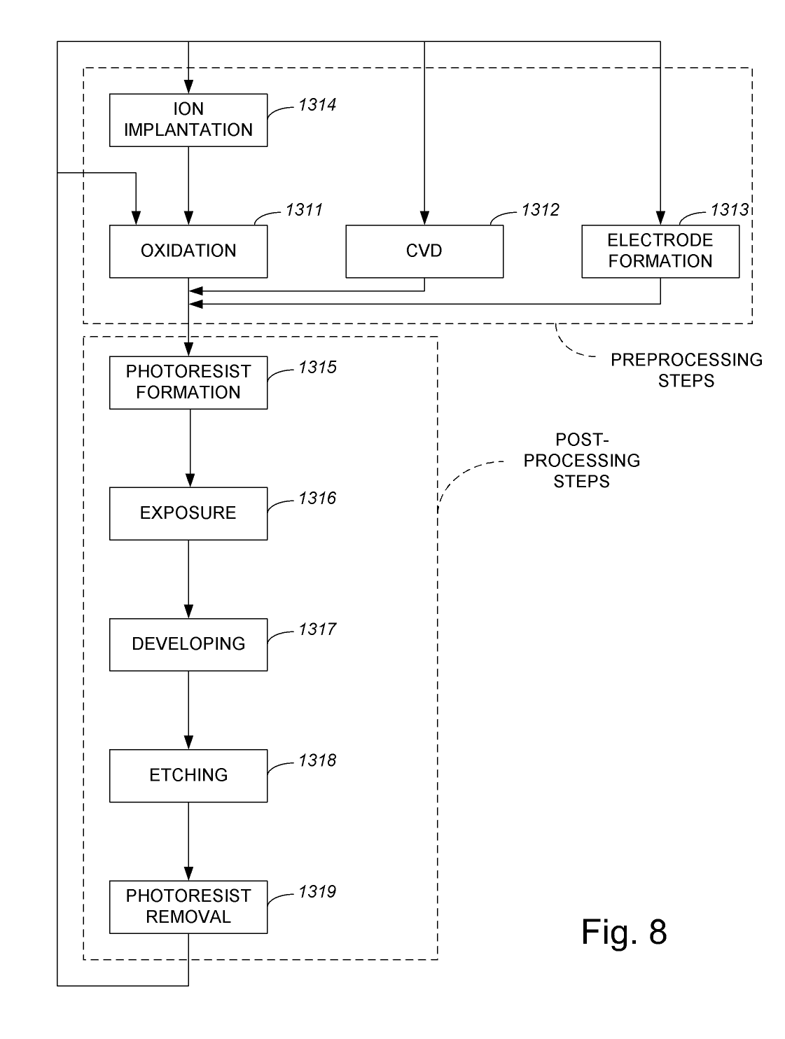

Further, semiconductor devices may be fabricated using systems described above, as will be discussed with reference to FIG. 8. The process begins at step 1301 in which the function and performance characteristics of a semiconductor device are designed or otherwise determined. Next, in step 1302, a reticle (mask) in which has a pattern is designed based upon the design of the semiconductor device. It should be appreciated that in a parallel step 1303, a wafer is made from a silicon material. The mask pattern designed in step 1302 is exposed onto the wafer fabricated in step 1303 in step 1304 by a photolithography system. One process of exposing a mask pattern onto a wafer will be described below with respect to FIG. 8. In step 1305, the semiconductor device is assembled. The assembly of the semiconductor device generally includes, but is not limited to, wafer dicing processes, bonding processes, and packaging processes. Finally, the completed device is inspected in step 1306.

FIG. 8 is a process flow diagram which illustrates the steps associated with wafer processing in the case of fabricating semiconductor devices in accordance with an embodiment of the present invention. In step 1311, the surface of a wafer is oxidized. Then, in step 1312 which is a chemical vapor deposition (CVD) step, an insulation film may be formed on the wafer surface. Once the insulation film is formed, in step 1313, electrodes are formed on the wafer by vapor deposition. Then, ions may be implanted in the wafer using substantially any suitable method in step 1314. As will be appreciated by those skilled in the art, steps 1311-1314 are generally considered to be preprocessing steps for wafers during wafer processing. Further, it should be understood that selections made in each step, e.g., the concentration of various chemicals to use in forming an insulation film in step 1312, may be made based upon processing requirements.

At each stage of wafer processing, when preprocessing steps have been completed, post-processing steps may be implemented. During post-processing, initially, in step 1315, photoresist is applied to a wafer. Then, in step 1316, an exposure device may be used to transfer the circuit pattern of a reticle to a wafer. Transferring the circuit pattern of the reticle of the wafer generally includes scanning a reticle scanning stage which may, in one embodiment, include a force damper to dampen vibrations.

After the circuit pattern on a reticle is transferred to a wafer, the exposed wafer is developed in step 1317. Once the exposed wafer is developed, parts other than residual photoresist, e.g., the exposed material surface, may be removed by etching. Finally, in step 1319, any unnecessary photoresist that remains after etching may be removed. As will be appreciated by those skilled in the art, multiple circuit patterns may be formed through the repetition of the preprocessing and post-processing steps.

Although only a few embodiments of the present invention have been described, it should be understood that the present invention may be embodied in many other specific forms without departing from the spirit or the scope of the present invention. By way of example, a lithographic system which includes a piezoelectric actuator which serves as a vibration isolator has been described as including only a single reticle stage. In some embodiments, a piezoelectric actuator may be implemented in a system which includes a plurality of reticle stages, e.g., a fine stage and a coarse stage. Generally, lithographic systems which include either an AVIS or a piezoelectric actuator to isolate a reticle stage assembly from a lens assembly may be widely varied. For instance, a lithographic system may include a reaction frame instead of a counter mass arrangement to absorb reaction forces, as discussed above.

An AVIS has generally been described as being either passive or active. A passive AVIS has been described as including an air mount, while an active AVIS has been described as including a voice coil motor. It should be appreciated that substantially any suitable device may be used as a passive AVIS or an active AVIS. That is, the configuration of an AVIS may vary widely.

Each AVIS or piezoelectric actuator assembly has generally been described as being mounted substantially directly to a frame caster, e.g., through a frame such as a reticle frame to substantially isolate a lens assembly from vibrations associated with the movement of various stages. In one embodiment, an AVIS may instead be mounted substantially on the lens assembly in order to isolate the lens assembly from the vibrations, e.g., an AVIS which isolates a reticle stage assembly from a lens assembly may be substantially mounted on the lens assembly without departing from the spirit or the scope of the present invention.

The trajectory of a reticle has been described above as being altered such that the reticle effectively follows or tracks the trajectory of a wafer. It should be appreciated that instead of altering the actual trajectory of a reticle to track the trajectory of a wafer, the actual trajectory of the wafer may instead be altered to track the trajectory of the reticle. Typically, the trajectory of the reticle is altered due to the fact that there are fewer mechanism associated with a reticle stage assembly than there are associated with a wafer stage assembly, i.e., it may be less complicated to alter the trajectory of the reticle. In addition, the bandwidth associated with adjusting the trajectory of the reticle is higher than the corresponding bandwidth of the wafer.

The control logic or flow used to enable the trajectory of a reticle to track the trajectory of a wafer may vary widely. By way of example, position output signals associated with a reticle stage assembly and a wafer stage assembly may each be filtered before an error signal is determined without departing from the spirit or the scope of the present invention. Therefore, the present examples are to be considered as illustrative and not restrictive, and the invention is not to be limited to the details given herein, but may be modified within the scope of the appended claims.

1. An apparatus comprising:
an optical member;
a reticle assembly, the reticle assembly being arranged to be moved on a reticle stage base in a first direction;
a counter mass, the counter mass being arranged to move in a second direction when the reticle stage moves, the second direction being opposite from the first direction; and
a trim motor, the trim motor being arranged to position the counter mass, wherein the trim motor is vibrationally isolated form the optical member.

2. The apparatus of claim 1 wherein the counter mass is movable on the reticle stage base.

3. The apparatus of claim 1 further including:
an isolator assembly, the isolator assembly being arranged to vibrationally isolate the reticle stage base from the optical member.

4. The apparatus of claim 3 wherein the trim motor is vibrationally isolated from the reticle stage base.

5. The apparatus of claim 1 wherein the trim motor is vibrationally isolated from the reticle stage base.

6. The apparatus of claim 1 further including:
a frame structure, the frame structure being arranged to support the optical member through a first isolator assembly, the frame structure further being arranged to support the trim motor.

7. The apparatus of claim 6 wherein the frame structure supports the reticle stage base through a second isolator assembly.

8. The apparatus of claim 6 wherein the frame structure supports a wafer stage base, the wafer stage base being arranged to movably support the wafer stage.

9. An exposure apparatus comprising the apparatus of claim 1.

10. A device manufactured with the exposure apparatus of claim 1.

11. A wafer on which an image has been formed by the exposure apparatus of claim 9.

12. A method for operating a reticle in an apparatus, the apparatus including a stage device that retains the reticle and an optical member that is irradiated by a radiant energy including information associated with a pattern of the reticle, the method comprising:
moving the reticle using the stage device, wherein moving the reticle causes a reaction force;
absorbing the reaction force by utilizing a counter mass that is connected to the stage device; and
positioning the counter mass by utilizing a trim motor, wherein the trim motor is vibrationally isolated from the optical member.

13. The method of claim 12 wherein positioning the counter mass by utilizing the trim motor includes moving the counter mass on a reticle stage base of the apparatus.

14. The method of claim 13 wherein the reticle stage base is vibrationally isolated from the optical member.

15. The method of claim 14 wherein the trim motor is vibrationally isolated from the reticle stage base.

16. The method of claim 12 wherein the apparatus further includes a frame structure arranged to support the optical member through a first isolator assembly, the frame structure further being arranged to support the trim motor.

17. The method of claim 16 wherein the apparatus further includes a wafer stage base, the frame structure being arranged to support the wafer stage base, the method including:
moving the wafer stage over the wafer stage base.

18. The method of claim 12 wherein the method is an exposure method.

19. A device manufactured with the exposure method of claim 18.

20. A wafer on which an image has been formed by the exposure method of claim 19.
